(19) United States
(12) Patent Application Publication
(10) Pub. No.: US 2006/0084180 A1
(43) Pub. Date: Apr. 20, 2006

(54) Method for increasing the dynamic range of a cavity enhanced optical spectrometer

(76) Inventors: Barbara Paldus, Portola Valley, CA (US); Bruce Richman, Sunnyvale, CA (US); Alexander Kachanov, Sunnyvale, CA (US); Eric Crosson, Sunnyvale, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/966,315

(22) Filed: Oct. 14, 2004

(51) Int. Cl. G01N 24/00

(52) U.S. Cl. 436/171

(57) ABSTRACT

Target analytes present in low concentration as components in a gaseous admixture can be detected using a cavity enhanced optical spectrometer by a process comprising: i) identifying from the spectrum of the pure target analyte a series of absorption peaks free from spectral interference by peaks of any additional gaseous species which are present, the first member of the series being the strongest spectral absorption peak of said target analyte ii) identifying one or more successive peaks of the series which have an absorption that is weaker than the immediately previously identified peak of the series, iii) performing a spectral scan at the wavelengths of the peaks identified in steps i) and ii), and iv) calculating the concentration of the target analyte from the spectral scan of the admixture performed at the wavelength determined in step iii).

### FIELD OF THE INVENTION

This invention relates to a method for increasing the measurable concentration range (dynamic range) of a cavity enhanced optical spectrometer which can be either a cavity ringdown spectrometer (CRDS) or a cavity enhanced absorption spectrometer (CEAS) which is sometimes called an integrated cavity output spectrometer (ICOS) by analyzing selected strong and weak absorption bands of a target analyte.

### BACKGROUND OF THE INVENTION

Molecular absorption spectroscopy is a technique that uses the interaction of energy with a molecular species to qualitatively and/or quantitatively study the species, or to study physical processes associated with the species. The interaction of radiation with matter can cause redirection of the radiation and/or transitions between the energy levels of the atoms or molecules. The transition from a lower level to a higher level with an accompanying transfer of energy from the radiation field to the atom or molecule is called absorption. When molecules absorb light, the incoming energy excites a quantized structure to a higher energy level. The type of excitation depends on the wavelength of the light. Electrons are promoted to higher orbitals by ultraviolet or visible light, vibrations are excited by infrared light, and rotations are excited by microwaves. The infrared (IR) region is defined as extending from 1 to 50 μm. The 0.7 to 2.5 μm region is generally called the near-infrared (NIR), the 2.5 to 15 μm region is referred to as the mid-infrared and the 15 to 50 μm is called the far-infrared. The wavelengths of IR absorption bands are characteristic of specific types of chemical bonds, and IR spectroscopy finds its greatest utility in the identification of organic and organometallic molecules.

The data that is obtained from spectroscopy is called a spectrum. An absorption spectrum shows the absorption of light as a function of its wavelength. The spectrum of an atom or molecule depends on its energy level structure. A spectrum can be used to obtain information about atomic and molecular energy levels, molecular geometries, chemical bonds, the interactions of molecules, and related processes. Often, spectra are used to identify the components of a sample (qualitative analysis). Spectra may also be used to measure the amount of material in a sample (quantitative analysis). The transition moment for infrared absorption is:
R=<Xᵢ|u|Xⱼ>
where Xᵢ and Xⱼ are the initial and final states, respectively, and u is the electric dipole moment operator: u=u₀+(r−rₑ)du/dr+ . . . , where u₀ is the permanent dipole moment, which is a constant, r is the radial length of the bond, and rₑ is the average equilibrium bond length. Because <Xᵢ|Xⱼ>=0 R simplifies to:
R=<Xᵢ|(r−rₑ)du/dr|Xⱼ>

The result is that there must be a change in dipole moment during the vibration of the atoms of a molecule for the molecule to absorb infrared radiation. There is usually no dipole moment change during symmetric stretches of symmetric molecules, so that these transitions are usually not infrared active. FIG. 1 shows an example of two stretches for carbon dioxide (CO₂). The 7.46 μm symmetric stretch is infrared inactive, while the 4.26 μm asymmetric stretch is infrared active. Thus, only the 4.26 μm transition can be observed with conventional IR spectroscopy.

Gaseous molecules are found only in discrete states of vibration and rotation, called the ro-vibrational state. Each such state, identified by quantum numbers describing both the vibration and rotation, has a single energy which depends on said quantum numbers. In the dipole transitions described above, a single photon of radiation is absorbed, transforming the molecule from one ro-vibrational state to another. As the energies of the ro-vibrational states are discrete, so are the energies of the transitions between them. Therefore, a photon must possess a specific energy to be absorbed by a molecule to transform it between two given ro-vibrational states. Since the energy of a photon is proportional to the frequency of the radiation of which the photon is a part (or equivalently, inversely proportional to the wavelength), only discrete frequencies (wavelengths) can be absorbed by the molecule. The set of discrete frequencies (wavelengths), often called absorption lines, at which a particular species of molecule absorbs, is called the absorption spectrum of said molecule. The width in frequency (wavelength) of each absorption line depends on the specific ro-vibrational transition, the pressure and temperature of the gas containing the molecule, and the presence of other types of molecules in said gas. Each species of molecule has a unique absorption spectrum, by which the species of molecule may be identified. Since the energies of different rotational states of a gaseous molecule are typically spaced much more closely than the energies of different vibrational states, then the absorption lines occur in sets, each set corresponding to a single vibrational transition, and many rotational transitions. These sets of absorption lines are called absorption bands. An instrument which measures an absorption spectrum is called a spectrometer.

| Functional | | Spectral Range | Spectral Range |
|---|---|---|---|
| Group Name | Bond | (μm) | (cm⁻¹) |
| Hydroxyl | O—H | 2.770-2.747 | 3610-3640 |
| Aromatic Ring | C6H6 | 3.226-3.333 | 3000-3100 |
| Alkene | C═C—H | 3.247-3.311 | 3020-3080 |
| Alkane | C—C—H | 3.378-3.509 | 2850-2960 |
| Carbonyl | C═O | 5.714-6.061 | 1650-1750 |
| Nitrile | C≡N | 4.425-4.525 | 2210-2260 |
| Amine I | N—H | 2.857-3.030 | 3300-3500 |
| Amine II | C—N | 7.353-8.475 | 1180-1360 |

Table 1, above, summarizes mid-infrared vibrational bands that are characteristic of common molecular functional groups.

Molecular vibrational bands can be likened to the acoustic frequencies of a string (such as on a violin). Similarly, molecular bands have overtones, which are harmonics of the vibrational motion. The original stretch that produces mid-infrared absorption bands is called the fundamental. A fundamental has many harmonics, as well as combinations of harmonics at a wide variety of frequencies. The absorption at the harmonics is always less than at the fundamental, and can decrease significantly for higher harmonics. Therefore, these overtone transitions are referred to as weak overtones.

In the NIR, all the vibrational transitions are harmonics of fundamental, mid-infrared bands. These transitions can be a hundred to ten thousand times weaker than their mid-infrared counterparts. Standard methods, such as Fourier Transform Infrared Spectroscopy (FTIR), commonly used to characterize mid-infrared transitions, normally have difficulty detecting these weak absorption features in the NIR spectral region. Therefore, more sensitive detection methods are required to measure NIR absorption features.

Moreover, because overtone bands and combinations of overtone bands often overlap in wavelength (frequency), the NIR is normally filled with dense bands of absorption lines. It is therefore not uncommon to find spectral regions where the same molecular species has both strong and weak transitions that are co-located in wavelength (frequency). An example of a CO₂ spectrum is shown in FIG. 2. Two bands should be noted: the stronger band is in the 1.606 μm region, centered at 6226.65 cm⁻¹ while the weaker band is in the 1.613 μm wavelength range centered at 6199.63 cm⁻¹. The difference in peak absorption between the strong and weak band is a factor of about 10. Other even weaker bands are also present in this wavelength region, but are not as easily visible.

Measuring the concentration of an absorbing species in a sample is accomplished by applying the empirical Beer-Lambert Law. The Beer-Lambert law (or Beer's law) is the linear relationship between absorbance and concentration of an absorbing species. The Beer-Lambert law can be derived from an approximation for the absorption coefficient of molecule by approximating the molecule by an opaque disk whose cross-sectional area, σ, represents the effective area seen by a photon of frequency ω. If the frequency of the light is far from resonance, the area is approximately 0, and if ω is at resonance the area is a maximum. Taking an infinitesimal slab, dz, of a sample as shown in FIG. 3, Iₒ is the intensity entering the sample at z=0, I_{z} is the intensity entering the infinitesimal slab at z, dI is the intensity absorbed in the slab, and I is the intensity of light leaving the sample. Then, the total opaque area on the slab due to the absorbers is σNA dz. Then, the fraction of photons absorbed will be σNA(dz/A) so,
dI/I_{z}=−σN dz

Integrating this equation from z=0 to z=b gives:
ln(I)−ln(Iₒ)=−σN L or −ln(I/Iₒ)=σN L.
Since N (molecules/cm³)*(1 mole/6.023×10²³ molecules)*1000 cm³/liter=C (moles/liter) and 2.303*log(x)=ln(x)
Then:
−log(I/Iₒ)=σ(6.023×10²⁰/2.303) C L or −log(I/Iₒ)=A=α_{M} L C where α_{M}=σ(6.023×10²⁰/2.303)=σ2.61×10²⁰

Typical cross-sections and molar absorptivities are:

| | σ (cm²) | ε (M⁻¹ cm⁻¹) |
|---|---|---|
| Atoms | 10⁻¹² | 3 × 10⁸ |
| Molecules | 10⁻¹⁶ | 3 × 10⁴ |
| Infrared | 10⁻¹⁹ | 3 × 10 |
| Raman scattering | 10⁻²⁹ | 3 × 10⁻⁹ |

The general Beer-Lambert law is usually written as:
A(λ)=α(λ)L=Cε(λ)L (1)
where A(λ) is the measured absorbance, α(λ) is a wavelength-dependent absorption coefficient, ε(λ) is a wavelength-dependent extinction coefficient, L is the path length, and C is the analyte concentration, as shown in FIG. 3. When working in concentration units of molarity, the Beer-Lambert law is written as:
A(λ)=α_{M}(λ)L=Cε_{M}(λ)L.
where α_{M}(λ) is the wavelength-dependent molar absorption coefficient having units of cm⁻¹M⁻¹, and ε_{M}(λ) is the wavelength dependent molar extinction coefficient.

A working curve is a plot of the analytical signal (the instrument or detector response) as a function of analyte concentration. These working curves for any given analyte are obtained by measuring the signal from a series of standards of known concentration. The working curves are then used to determine the concentration of an unknown sample or to calibrate the linearity of an analytical instrument.

Experimental measurements are usually made in terms of transmittance (T), which is defined as:
T=I/Iₒ
where I is the light intensity after it passes through the sample and Iₒ is the initial light intensity. The relation between A and T is:
A=−log T=−log(I/Iₒ) (2)

However, modern absorption instruments can usually display the data as transmittance, %-transmittance, or absorbance. An unknown concentration of an analyte can be determined by measuring the amount of light that a sample absorbs and then applying Beer's law. If the absorption coefficient is not known, the unknown concentration can be determined using a working curve of absorbance versus concentration derived from known standards.

Standards are samples containing a known concentration of a known analyte. They provide a reference to determine unknown concentrations or to calibrate analytical instruments. The accuracy of an analytical measurement is how close a result comes to the true value. Determining the accuracy of a measurement usually requires calibration of the analytical method and instrument against a known standard. This is often done with standards of several different concentrations to make a calibration or working curve. Standard reference materials are available from standards laboratories such as the National Institute for Standards and Technology (NIST) or the International Atomic Energy Association (IAEA).

The linearity of the Beer-Lambert law is limited by both chemical and instrumental factors. Causes of nonlinearity include:
deviations in absorption coefficients at high concentrations (>0.01M) due to electrostatic interactions between analyte molecules in close proximity
scattering of light due to particulates present in the sample
fluoresecence or phosphorescence of the sample
changes in sample refractive index at high analyte concentration
shifts in chemical equilibrium as a function of concentration
non-monochromatic radiation and
stray light

Equations (1) and (2) show that the ability of a spectrometer to detect a specific concentration depends not only on the path length through the sample, but also on the intensity noise of both the light source and the detector. Sensitivity can be quantified as a minimum detectable absorption loss (MDAL), i.e., the normalized standard deviation of the smallest detectable change in absorption. MDAL typically has units of cm⁻¹. Sensitivity can also be defined as the achievable MDAL in a one second measurement interval, and has units of cm⁻¹ Hz^{-1/2}. Sensitivity accounts for the different measurement speeds achieved by diverse absorption-based methods and is a figure of merit for any absorption-based technique.

Typically, a spectral feature (called an “absorption peak”) of the target species is measured in order to obtain its concentration. Although most species will absorb light at one or more wavelengths, the total spectral profile of any particular species is unique.

The ability of a spectrometer to distinguish between two different species absorbing at similar wavelengths is called selectivity. Because spectral features narrow as the sample pressure is reduced, selectivity can be improved by reducing the operating pressure. However, the spectrometer must still be able to resolve the resulting spectral lines. Thus, selectivity ultimately depends on spectral resolution. Spectral resolution, typically measured in frequency (MHz), wavelength (picometers) or wave numbers (cm⁻¹ ), is an important figure of merit for a spectrometer

For a spectrometer, the range of optical absorption that is is able to measure is called the optical dynamic range (ODR). The ODR of an optical instrument is based primarily on the optical noise of the system at a given analyte concentration. At the low analyte concentration end, the transmission of light is adequate to produce a high signal-to-noise ratio at the detector so that sensitivity is limited by fluctuations in the light source intensity. At the high analyte concentration end, most of the light is absorbed by the sample, so that the instrument capability is limited by detector noise. For any given analyte, the range of concentrations that the instrument can detect is called its concentration dynamic range (CDR). Typically, the CDR is the difference between the lowest and the highest detectable concentration of a given analyte. It should be born in mind that the CDR and ODR have different limitations: the ODR is fixed by the instrument hardware, while the CDR depends both on the CDR and on the absorption feature of the analyte being examined. If the instrument exhibits nonlinear behavior at either end of the dynamic range, the useable dynamic range is restricted to those analyte concentrations where instrument response to concentration changes remains linear. This is called the linear dynamic range, as distinguished from the theoretical maximum dynamic range of operation.

Optical detection is the determination of the presence and/or concentration of one or more target species within a sample by illuminating the sample with optical radiation and measuring optical absorption by the sample. A correspondingly wide variety of optical detection methods are known. Instruments that measure the absorption directly have a large dynamic range, but cannot accurately measure the absolute absorption signal.

Examples of such instruments include FTIR, NDIR and TDLAS. For example, FTIR spectrometers, can often provide a dynamic range of many orders of magnitude. For example, a commercially available MKS “Online Purity Analyzer” can operate in a range of from 10 ppb to 100%. This corresponds to a dynamic range of eight orders of magnitude. Non-dispersive infrared (NDIR) instruments can also have an extended dynamic range. For example, one commercial instrument (the Licor LI-7000) can detect CO₂ from 3 ppb to 3000 ppm, which corresponds to six orders of magnitude. Tunable diode laser based absorption spectrometer (TDLAS) instruments can also achieve a five to six orders of magnitude dynamic range, typically measuring species concentrations as low as single digit ppm and as high as 100%.

None of the above-mentioned existing absorption spectroscopy methods can measure absolute absorption, regardless of whether they utilize incoherent or monochromatic light sources. Therefore, all of these approaches require calibration.

Cavity enhanced optical detection entails the use of a passive optical resonator, also referred to as a cavity, to improve the performance of an optical detector. Cavity enhanced absorption spectroscopy (CEAS), integrated cavity output spectroscopy (ICOS) and cavity ring down spectroscopy (CRDS) are three of the most widely used cavity enhanced optical detection techniques. The teaching of U.S. Pat. Nos. 5,528,040; 5,912,740; 6,795,190 and 6,466,322 which describe these techniques are hereby incorporated herein by this reference.

The intensity of single-mode radiation trapped within a passive optical resonator decays exponentially over time, with a time constant T, which is often referred to as the ring-down time. In practice, it is desirable to ensure that only a single resonator mode has an appreciable amplitude, since excitation of multiple resonator modes leads to multi-exponential radiation intensity decay (i.e., multiple time constants), which significantly complicates the interpretation of measurement results. The ring-down time T depends on the cavity round trip length and on the total round-trip optical loss within the cavity, including loss due to absorption and/or scattering by one or more target species within a sample positioned inside the cavity. Thus, measurement of the ring-down time of an optical resonator containing a target species provides spectroscopic information on the target species. Both CRDS and CEAS/ICOS are based on such a measurement of τ. Off axis ICOS eliminates the resonances of the optical cavity but still preserves its amplifying properties. CRDS is used in conjunction with CEAS/ICOS and off-axis ICOS to calibrate the spectrometer.

In CRDS, an optical source is usually coupled to the resonator in a mode-matched manner, so that the radiation trapped within the resonator is substantially in a single spatial mode. The coupling between the source and the resonator is then interrupted (e.g., by blocking the source radiation, or by altering the spectral overlap between the source radiation and the excited resonator mode). A detector typically is positioned to receive a portion of the radiation leaking from the resonator, which decays in time exponentially with a time constant τ. The time-dependent signal from this detector is processed to determine τ (e.g., by sampling the detector signal and applying a suitable curve-fitting method to a decaying portion of the sampled signal). Note that CRDS entails an absolute measurement of τ. Both pulsed and continuous wave laser radiation can be used in CRDS with a variety of factors influencing the choice. The articles in the book “Cavity-Ringdown Spectroscopy” by K. W. Busch and M. A. Busch, ACS Symposium Series No. 720, 1999 ISBN 0-8412-3600-3, including the therein cited references, cover most currently reported aspects of CRDS technology.

Single spatial mode excitation of the resonator is also usually employed in CEAS(ICOS)) or off-axis ICOS but CEAS differs from CRDS in that the wavelength of the source is swept (i.e., varied over time), so that the source wavelength coincides briefly with the resonant wavelengths of a succession of resonator modes. A detector is positioned to receive radiation leaking from the resonator, and the signal from the detector is integrated for a time comparable to the time it takes the source wavelength to scan across a sample resonator mode of interest. The resulting detector signal is proportional to τ, so the variation of this signal with source wavelength provides spectral information on the sample. Note that CEAS entails a relative measurement of τ. The published Ph.D. dissertation “Cavity Enhanced Absorption Spectroscopy”, R. Peeters, Katholieke Universiteit Nijmegen, The Netherlands, 2001, ISBN 90-9014628-8, provides further information on both CEAS and CRDS technology and applications CEAS is discussed in a recent article entitled “Incoherent Broad-band Cavity-enhanced Absorption Spectroscopy by S. Fiedler, A. Hese and A, Ruth Chemical Physics Letters 371 (2003) 284-294. The teaching of U.S. Pat. No. 6,795,190 which describes ICOS and off-axis ICOS are incorporated herein.

In cavity enhanced optical detection, the measured ring-down time depends on the total round trip loss within the optical resonator. Absorption and/or scattering by target species within the cavity normally accounts for the major portion of the total round trip loss, while parasitic loss (e.g., mirror losses and reflections from intracavity interfaces) accounts for the remainder of the total round trip loss. The sensitivity of cavity enhanced optical detection improves as the parasitic loss is decreased, since the total round trip loss depends more sensitively on the target species concentration as the parasitic loss is decreased. Accordingly, both the use of mirrors with very low loss (i.e., a reflectivity greater than 99.99 per cent), and the minimization of intracavity interface reflections are important for cavity enhanced optical detection. Although the present invention will be described primarily in the context of CRDS, it should be understood that the methodology is also applicable to CEAS.

### BRIEF DESCRIPTION OF THE DRAWINGS

FIG. 1 is a drawing showing an asymmetric and symmetric stretch for the CO₂ molecule.

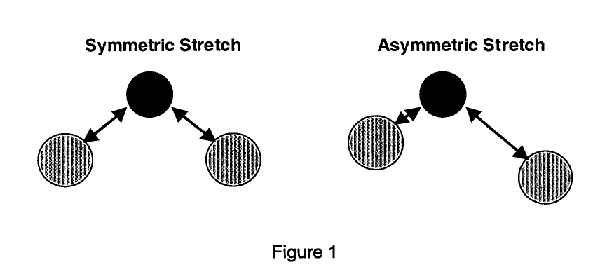

FIG. 2 shows the absorption spectrum of CO₂ between 1.595 and 1.625 μm (380 ppmv at 140 Torr).

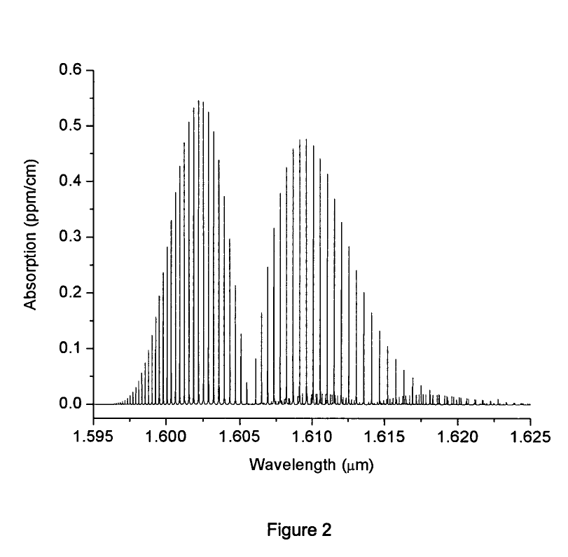

FIG. 3 illustrates the basis for the calculation of Beer's Law.

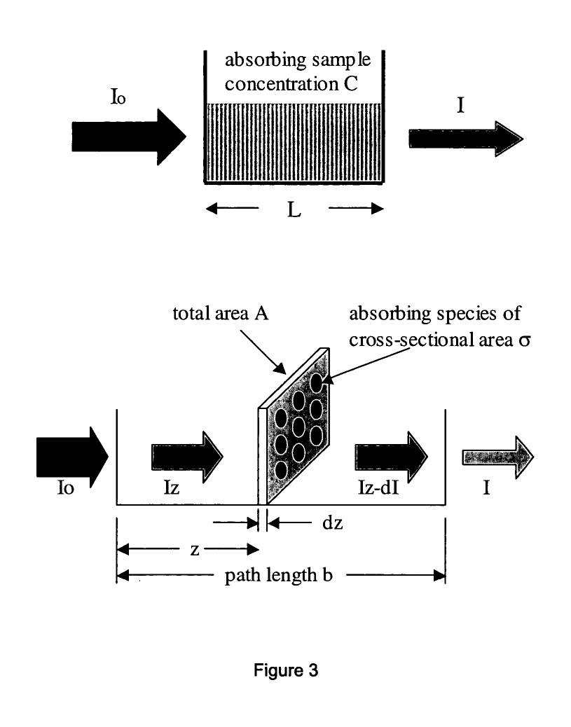

FIG. 4 shows an absorption spectrum of CO2 at 50 Torr between 6236.8 and 6237.6 cm⁻¹

FIG. 5 shows the spectrum of multiple isotopomers of Methane (CH₄) between 1.64 and 1.69 μm.

FIG. 6 shows the spectrum of multiple isotopomers of CO₂ between 1.5965 and 1.5995 μm.

### DESCRIPTION OF THE INVENTION

As previously indicated, none of the above-mentioned prior art absorption spectroscopy methods can measure absolute absorption, regardless of whether they utilize incoherent thermal light sources or monochromatic lasers. Therefore, all of these approaches require calibration. Cavity ring-down spectroscopy (CRDS) is an optical absorption method that does not require calibration provided only that the extinction coefficient for a target species absorption feature is known. However, typical CRDS or ICOS systems exhibit only about four orders of magnitude dynamic range. It is the purpose of the present invention to provide a method that substantially increases the dynamic range of a CRDS or ICOS system, thereby to permit its use in applications which have heretofore not been accessible by CRDS or ICOS spectroscopic methods. Suitable lasers for the practice of the current invention include Distributed Bragg Reflector Lasers, Optical Parametric Oscillators, Optical Parametric Generators, Quantum Cascade Lasers, External Cavity Diode Lasers and Distributed Feedback Lasers. All these lasers are of the types known to the skilled artworker. Depending on the precise nature of the target analyte it may be possible to utilize a single laser which is tunable over a wavelength band suitable to cover all the absorption peaks of interest. For example, Distributed Feedback Lasers and Quantum Cascade Lasers are tunable to emit radiation over a relatively broad wavelength range by varying the pump current to the laser and/or by altering the operating temperature of the laser. If an external cavity diode laser is utilized it will advantageously have a micromotor for wide range (coarse) tuning and a piezoelectric transducer (PET) for narrow range (fine) tuning. Another suitable laser is an Optical Parametric Oscillator, which is a type of laser which provides a broad tuning range.

Cavity ring-down spectroscopy (CRDS) is based on the principle of measuring the rate of decay of light intensity inside a stable optical resonator, called the ring-down cavity (RDC). Once sufficient light is injected into the RDC from a laser source, the input light is interrupted, and the light transmitted out of the cavity through one of the RDC mirrors is monitored using a photodetector. The transmitted light, I(t, λ), from the RDC is given by the equation:

$$I ( t , λ ) = {I}_{0} {ⅇ}^{- t / τ ( λ )} \qquad ( 3 )$$

where I₀ is the transmitted light at the time the light source is shut off, τ(λ) is the ring-down time constant, and R(λ)=1/τ(λ) is the decay rate. The transmitted light intensity decays exponentially over time.

The decay rate is proportional to the total optical losses inside the RDC, L_{cav}(λ)=L_{scat}(λ)+Lₜᵣₐₙₛ(λ), and sample absorbance A(λ)=α(λ)lᵣₜ, through the equation:
R(λ, C)=1/τ(λ)=L_{cav}/tᵣₜ+cε(λ)C, (4)
where lᵣₜ is the cavity round-trip length, tᵣₜ=lᵣₜ/c is the cavity round-trip time, c is the speed of light, L_{scat} is the round-trip scattering plus absorption loss of the empty cavity, and Lₜᵣₐₙₛ is the round-trip mirror transmission. The effective path length of the measurement is l_{eff}=lᵣₜ/L_{cav}. For typical mirrors having a reflectivity exceeding 99.99%, and scattering plus absorption losses of less than 0.001%, the path length enhancement can exceed 10⁴. A stable optical RDC can accomplish this enhancement for sample volumes as small as 25 mL. The benefits of smaller sample volumes manifest themselves in faster flow rates through the system, and reduced sample memory.

Equation (5) shows that the sample concentration, C, can be found from the spectrum obtained by taking the difference between an empty cavity (C=0) and a cavity containing a sample:
C=[cε(λ)]⁻¹ [R(λ,C)−R(λ,0)] (5)

If the absorption cross section and line shape parameters of the sample are known, then the concentration of the sample can then be computed. Note that, as seen from equation (5), a CRDS measurement is truly absolute when compared with NDIR, FTIR, or multi-pass TDLAS. The measurement is not dependent on the initial intensity of the light inside the cavity. A zero CRDS measurement is produced if, and only if, the sample concentration is zero, independent of drifts in system subcomponents or operating conditions.

In traditional spectroscopy the detector measures the intensity of the light transmitted through the sample. The dynamic range of the instrument is therefore proportional to the dynamic range of the detector. For most near-infrared photodiode based detectors, this range is typically five to six orders of magnitude. However, for CRDS, the ring-down rate is detected from the transmission of the circulating light inside the RDC. Because the decay waveform is digitized, there are two parameters that determine the ability of the instrument to measure the concentration: the digitization rate, and the signal to noise ratio of the decay waveform based on the digitization resolution of the detector voltage. In performing a spectroscopic analysis of an analyte in accordance with the present invention, it is advantageous to select a particular absorption line and measure the peak height, peak profile and/or peak area.

At low concentrations, the sample absorption is less than or comparable to the optical losses of the cavity, so that injection of light into the cavity is efficient, and the resulting ring-down waveform will have both a large initial amplitude and a long decay constant. Thus, its digitization is straightforward because the signal-to-noise ratio will be high, and the decay time constant is much longer than the digitization time. In this regime, CRDS technology achieves excellent sensitivity, accuracy, and precision. When one encounters high concentrations, however, the absorption is high, which decreases the cavity finesse, and thus the decay time constant can become very short, and approach the digitization time. High absorption also reduces the initial signal amplitude. If a certain precision P is required, for example 1%, (P=0.01) then the decay waveform must be resolved in both voltage and time, with a precision of better than 1%. For example, assume a 5 ns digitization interval, and an empty cavity decay time constant of 33 μs. The shortest measurable time constant with 1% precision approximately satisfies the relationship:
P=(5 ns/τ)N^{-1/2}
where N=4τ/(5 ns) is the number of digitizations in four decay times during a single ring-down event,
   so that P=0.5(5 ns/τ)^{3/2}

We solve P=0.01, to find τ=68 ns. Thus, the dynamic range of the CRDS instrument becomes constrained by being able to only resolve decay times that are about 13 times greater than the digitization time. If there is adequate cavity transmission at a decay constant of 68 ns, then the ratio of the concentration of sample producing an optical loss corresponding to a 68 ns time constant compared to the ratio of the sample producing a 33 μs constant is 537.6:1. Thus, the dynamic range for a sampling time for 5 ns and a precision of 1% is about 500. If one further averages 100 decay times at each wavelength, the system resolution improves by another factor of 10, so that it becomes possible to extend the dynamic range of the instrument to more than three orders of magnitude. Moreover, note that the underlying assumption is that there is enough light built up inside the resonator at high concentrations to provide good digitization precision on the detector voltage. If the light transmitted by the cavity decreases substantially at high concentrations (which is typical of such optical cavity based systems especially those involving liquid samples), then dynamic amplification of the detector output will be required to obtain the full dynamic range of the digitizer.

A CRDS instrument measures optical loss as 1/cτ. The optical dynamic range (ODR) of the instrument can be approximated as follows: ODR=1/single shot error×N^{-1/2} where N samples are averaged. For a typical CRDS instrument the ODR is ˜5×10⁴. The concentration dynamic range (CDR) is then determined by multiplying the ODR by the required precision for the lowest concentration. For example, for a 1% precision the CDR is 500 for an ODR of 50,000.

Overall, however, it is clear that the dynamic range of a CRDS system is dependent on the digitizer. Even if the digitization interval were 1 ns, the dynamic range of CRDS would still be effectively limited to the ratio of the empty cavity decay time to the digitization time. As the finesse of the cavity is increased to increase the decay time, cavity transmission for a laser having a fixed linewidth decreases, so that the signal to noise ratio decreases. If the transmitted light from the RDC becomes so weak that the signal to noise ratio, even upon amplification, is worse than the expected precision, then the overall dynamic range will again be limited. Thus, there is a tradeoff between cavity finesse, laser line width, digitization noise on the exponential waveform, and digitization sampling rate.

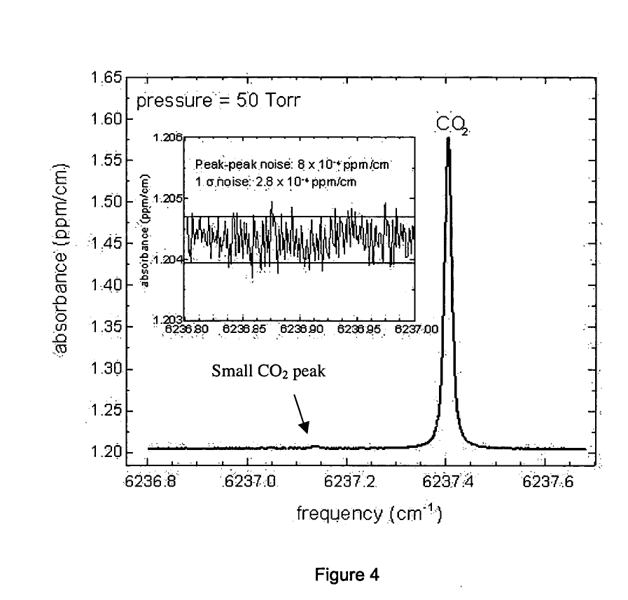

Thus, the CRDS system is ultimately limited by the digitization hardware and the optical hardware. In all cases for a single absorption feature, it is difficult to enable the dynamic range of a CRDS system to exceed four orders of magnitude. However, we have found that the dynamic range can be expanded further, by exploiting the spectroscopic features of the target species and measuring more than one spectral feature for each target analyte. The strongest interference free absorption peak within the tunable wavelength range of the instrument is normally chosen to achieve high sensitivity detection. As was described earlier, particularly in the near-infrared, but also in the far-infrared, target species have absorption lines having widely varying greater or lesser peak absorption. By selecting spectrally neighboring strong and weak lines, we have found that the dynamic range of a CRDS can be significantly increased. Consider, as an example, the two absorption features of CO₂ shown in FIG. 4 at ˜6237.14 cm⁻¹ (weak) and 6237.4 cm⁻¹ (strong). These two spectral lines can be accessed with even a narrowly tunable laser. The small peak has about two orders of magnitude (100 times) less absorption than the large peak. For other molecules, such peaks may be spaced more closely together or more widely separated. However, by using a broadly tunable laser, even widely separated peaks can be readily accessed.

By measuring the large peak at a relatively low concentration, and then measuring the small peak at a relatively high concentration, one can obtain two overlapping concentration dynamic ranges, which are two orders of magnitude apart. The CDR is thereby increased by a factor of 100. Assume that the ODR is 10,000. For example, if the precision is specified at 1%, then both CDRs will be 100:1 and the net combined CDR will be four orders of magnitude with a factor of 100 gained (without losing the precision specification). If only 10% precision is required, then both CDRs will be 1000:1 and the net CDR will be five orders of magnitude.

Again the CDR is increased 100 times. Note the inherent trade off between precision and concentration dynamic range so that the greater the required precision, the narrower the useable concentration dynamic range. Moreover, if a measurement precision is specified then the different spectral feature absorptions strengths cannot have a ratio that exceeds the precision or the concentration ranges will not be overlapping, resulting in concentrations that the system cannot measure.

The process of the present invention encompasses several alternative embodiments for measuring the concentration of one, or in some instances more than one gaseous target analyte present at low concentration. In a first embodiment, the target analyte is present in an admixture with at least one additional gaseous species and is detected using a cavity enhanced optical spectrometer by a process comprising:
i) identifying from the spectrum of the pure target analyte a series of absorption peaks, each member of said series being at the spectrometer operating pressure: a) present in the wavelength emission range of said spectrometer, and b) within said emission range free from spectral interference by peaks of any of said additional gaseous species, the first member of the series being the strongest spectral absorption peak of said target analyte
ii) identifying one or more successive peaks of the series which have an absorption that is weaker than the immediately previously identified peak of the series by a factor of from about 3 to about 10³,
iii) performing a spectral scan at the wavelength of the peaks identified in steps i) and ii) and determining which wavelength provides a cavity ringdown time of from about 100 ns to about 100 μs for said admixture, and
iv) calculating the concentration of the target analyte from the spectral scan of said admixture performed at the wavelength determined in step iii).

A second embodiment of the present invention provides a process for measuring the concentrations of at least two gaseous target analyte species present in a gaseous admixture comprising at least two different chemical compounds or at least two different isotopomers of the same chemical compound using a cavity enhanced optical spectrometer, the process comprising:
i) identifying a spectral absorption peak for each said target analyte species which peaks are: a) present in the wavelength emission range of said spectrometer, and b) are free from spectral interference at the spectrometer operating pressure by peaks of any of the other compounds or isotopomers present in said admixture, and whereby the height of each of the identified absorption peaks is within a factor of 10 of the height of the other identified peaks,
ii) performing a spectral scan at the wavelength of each of the peaks identified in step i), and
iii) calculating the concentration of each target analyte species from said spectral scan.

Yet another embodiment provides a process for measuring the concentrations of at least two gaseous target analyte species present in a gaseous admixture comprising at least two different chemical compounds or at least two different isotopomers of the same chemical compound using a cavity enhanced optical spectrometer, said process comprising:
i) identifying from the spectrum of each of the target analytes a series of absorption peaks, each member of said series being, at the spectrometer operating pressure: a) present in the wavelength emission range of said spectrometer, and b) within said emission range free from spectral interference by peaks of any other species present in said admixture, the first member of each series being the strongest spectral absorption peak of each said target analyte,
ii) identifying one or more additional peaks of each series which have an absorption peak that is successively weaker than the immediately previously identified peak of the same series by a factor of from about 3 to about 10³,
iii) performing a spectral scan at the wavelength of each of the peaks identified in steps i) and ii) and selecting an absorption peak of each series the wavelength of which provides a cavity ringdown time of from about 100 ns to about 100 μs for said admixture, and whereby the height of each selected absorption peaks is within a factor of 10 of the height of the other selected peaks,
iv) calculating the concentration of each target analyte from the spectral scan of said admixture performed at the wavelengths determined in step iii).

A further embodiment of the present invention is a process for measuring the concentration of a plurality of gaseous target analytes present at low concentration in an admixture with at least one additional gaseous species forming the major portion of said admixture using a cavity enhanced optical spectrometer, said process comprising:
i) identifying from the spectrum of each of the pure target analytes a series of absorption peaks, each member of said series being, at the spectrometer operating pressure: a) present in the wavelength emission range of said spectrometer, and b) within said emission range free from spectral interference by peaks of any of any other species present in said admixture, the first member of the series being the strongest spectral absorption peak of each of said target analytes
ii) identifying one or more additional peaks each series which have an absorption that is weaker than the immediately previously identified peak of the same series by a factor of from about 3 to about 10³,
iii) performing a spectral scan at the wavelength of the peaks identified in steps i) and ii) and selecting an absorption peak of each series the wavelength of which provides a cavity ringdown time of from about 100 ns to about 100 μs for said admixture, and
iv) calculating the concentration of each of the target analytes from the spectral scan of said admixture performed at the wavelength determined in step iii).

To be able to measure across the entire concentration range of any given analyte it is desirable that the height of each identified absorption peak in the series for that analyte differ from the immediately previously identified peak by a factor of no more than the CDR of the successive peak.

This observation can be expanded to provide a process for selecting the series of spectral features for a target analyte that have a decreasing absorption peak height corresponding to the required precision. For a 1% precision, for example, if one identifies three peaks where the second peak is 100 times weaker than the first and the third is 100 times weaker than the second, then the dynamic range can be increased up to about eight orders of magnitude, all the while maintaining the requisite precision and avoiding gaps in the measureable CDR.

The principle for selecting absorption lines having different absorption peak heights in order to maximize the dynamic range of a CRDS instrument without losing precision can be extended to allow CRDS to measure isotopic ratios of an analyte with high precision. For isotopomers of a given species, the natural abundance of the less abundant isotopes is generally much lower than the predominant isotope so that its absorption features will normally be much smaller. For example, ¹³C has only a 1% natural abundance, so that in natural CO₂ the spectral features of ¹³CO₂ will be 100 times smaller than those of ¹²CO₂.

For an instrument, such as CRDS, that has a dynamic range of 10⁴, this means that if the spectral features are not selected properly, the precision for measuring changes in these isotopic ratios would be adversely affected. Specifically, only a precision of 100:1 could be achieved for one of the isotopomers if the lines were poorly chosen. Typical isotopic measurement requires precisions exceeding 1000:1.

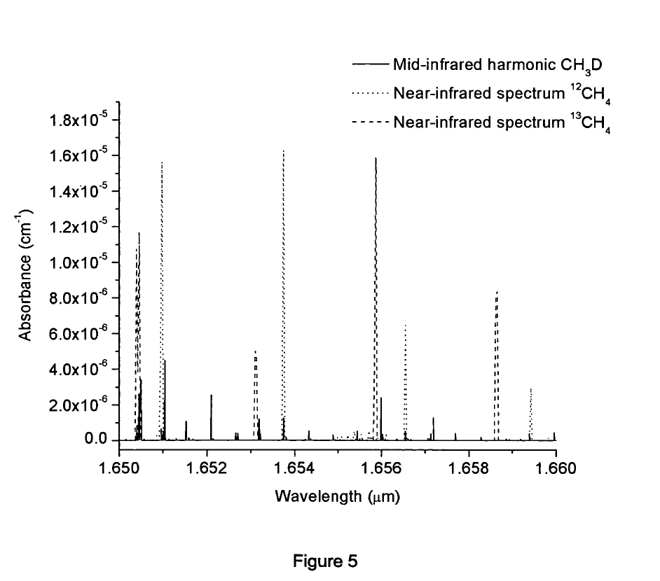

We have developed a better methodology that can be applied to maximize system performance. The isotope lines used for CRDS measurements can be selected to compensate for the discrepancy in natural isotopic abundance. The measurement of changes in isotope ratios is complementary to the dynamic range extension solution, i.e., the strongest line of the isotope having the smallest natural abundance is matched to the weakest line of the isotope having the largest natural abundance. FIG. 5 shows the result of applying such a method to detection of the isotopes of Methane. The resulting expected fractional change that is measurable for 10 ppm of methane is estimated to be better than 1 part in 1,000for a typical CRDS instrument. Note that peaks can be found for both isotopes of Methane, namely ¹³CH₄, which has a 1% natural abundance, and CH₃D, which only has a 0.0016% natural abundance.

Typical tuning ranges of currently available laser sources are 30 GHz of continuous, high resolution (resolution better than 10 MHz) current tuning for a DFB laser, with a total tuning range (range of current tuning increments) of 3 to 4 nm, based on temperature tuning. It is relatively straightforward to find combinations of overtone lines for either a single species or two isotopes of a species that fall within such a tuning range. It is also possible to find distributed feedback (DFB) lasers operating from about 730 nm to about 2.5 μm today, so that it is possible to access two different overtone bands in a single CRDS instrument using two different DFB lasers, where the RDC mirrors have a dual-wavelength-range coating to accommodate the wavelengths of both sets of overtones.

Even more broadly tunable sources are becoming available. External cavity diode lasers (ECDLs) offer tuning ranges of at least 40 nm, and 120 nm will soon be possible. Optical parametric oscillators make even broader tuning ranges practical. Thus, it is possible to use spectral lines having very different absorption strengths that are either within a single ro-vibrational band, or bands that are adjacent or overlapping for narrowly tunable sources, or spectral lines that lie at different wavelengths and correspond to different overtones, where the harmonic attenuation of absorption strength (a factor of about 3 to 500, depending on the molecule) is exploited to enhance the dynamic range.

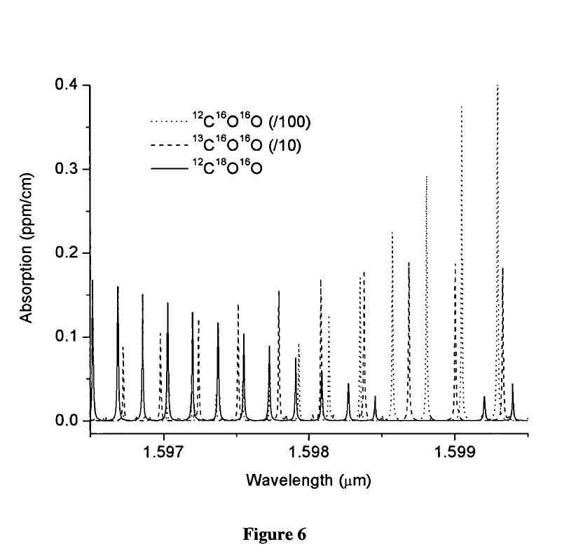

As shown in FIG. 5 for Methane, multiple isotopes of the same compound can be matched simultaneously for a current-only tuned DFB source, which has not heretofore been considered possible. For a thermally and current tuned DFB source for CO₂, the isotopes of both carbon and oxygen can be measured by finding the appropriate, closely spaced absorption lines as shown in FIG. 6. As tunability of the laser source is increased, the ability to find appropriately matched lines for virtually all isotopic species increases as well.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions herein relate to specific embodiments of the invention, it is to be understood that where a specific feature is disclosed in the context of a particular figure or embodiment, such feature can also be used, to the extent appropriate, in the context of another figure or embodiment, in combination with another feature, or in the invention in general.

Further, while the present invention has been particularly described in terms of certain preferred embodiments, the invention is not limited to such preferred embodiments. Rather, the scope of the invention is defined by the appended claims.

1. A process for measuring the concentration of a gaseous target analyte present at low concentration in an admixture with at least one additional gaseous species using a cavity enhanced optical spectrometer said process comprising:
i) identifying from the spectrum of the pure target analyte a series of absorption peaks, each member of said series being at the spectrometer operating pressure: a) present in the wavelength emission range of said spectrometer, and b) within said emission range free from spectral interference by peaks of any of said additional gaseous species, the first member of the series being the strongest spectral absorption peak of said target analyte
ii) identifying one or more successive peaks of the series which have an absorption that is weaker than the immediately previously identified peak of the series by a factor of from about 3 to about 10³,
iii) performing a spectral scan at the wavelength of the peaks identified in steps i) and ii) and determining which wavelength provides a cavity ringdown time of from about 100 ns to about 100 μs for said admixture, and
iv) calculating the concentration of the target analyte from the spectral scan of said admixture performed at the wavelength determined in step iii).

2. A process for measuring the concentrations of at least two gaseous target analyte species present in a gaseous admixture comprising at least two different chemical compounds or at least two different isotopomers of the same chemical compound using a cavity enhanced optical spectrometer, said process comprising:
i) identifying a spectral absorption peak for each said target analyte species which peaks are: a) present in the wavelength emission range of said spectrometer, and b) are free from spectral interference at the spectrometer operating pressure by peaks of any of the other compounds or isotopomers present in said admixture, and whereby the height of each of the identified absorption peaks is within a factor of 10 to 100 of the height of the other identified peaks,
ii) performing a spectral scan at the wavelength of each of the peaks identified in step i), and
iii) calculating the concentration of each target analyte species from said spectral scan.

3. A process for measuring the concentrations of at least two gaseous target analyte species present in a gaseous admixture comprising at least two different chemical compounds or at least two different isotopomers of the same chemical compound using a cavity enhanced optical spectrometer, said process comprising:
ii) identifying from the spectrum of each of the target analytes a series of absorption peaks, each member of said series being, at the spectrometer operating pressure: a) present in the wavelength emission range of said spectrometer, and b) within said emission range free from spectral interference by peaks of any other species present in said admixture, the first member of each series being the strongest spectral absorption peak of each said target analyte,
ii) identifying one or more additional peaks of each series which have an absorption peak that is successively weaker than the immediately previously identified peak of the same series by a factor of from about 3 to about 10³,
iii) performing a spectral scan at the wavelength of each of the peaks identified in steps i) and ii) and selecting an absorption peak of each series the wavelength of which provides a cavity ringdown time of from about 100 ns to about 100 μs for said admixture, and whereby the height of each selected absorption peaks is within a factor of 10 to 100 of the height of the other selected peaks,
iv) calculating the concentration of each target analyte from the spectral scan of said admixture performed at the wavelengths determined in step iii).

4. A process for measuring the concentration of a plurality of gaseous target analytes present at low concentration in an admixture with at least one additional gaseous species forming the major portion of said admixture using a cavity enhanced optical spectrometer, said process comprising:
i) identifying from the spectrum of each of the pure target analytes a series of absorption peaks, each member of said series being, at the spectrometer operating pressure: a) present in the wavelength emission range of said spectrometer, and b) within said emission range free from spectral interference by peaks of any of any other species present in said admixture, the first member of the series being the strongest spectral absorption peak of each of said target analytes
ii) identifying one or more additional peaks each series which have an absorption that is weaker than the immediately previously identified peak of the same series by a factor of from about 3 to about 10³,
iii) performing a spectral scan at the wavelength of the peaks identified in steps i) and ii) and selecting an absorption peak of each series the wavelength of which provides a cavity ringdown time of from about 100 ns to about 100 μs for said admixture, and
iv) calculating the concentration of each of the target analytes from the spectral scan of said admixture performed at the wavelength determined in step iii).

5. A process in accordance with claim 1 wherein said spectrometer utilizes as a light source at least one Distributed Bragg Reflector Laser, Optical Parametric Oscillator Laser, External Cavity Diode Laser, Quantum Cascade Laser or Distributed Feedback Laser

6. A process in accordance with claim 2 wherein said spectrometer utilizes as a light source at least one Distributed Bragg Reflector Laser, Optical Parametric Oscillator Laser, External Cavity Diode Laser, Quantum Cascade Laser or Distributed Feedback Laser.

7. A process in accordance with claim 3 wherein said spectrometer utilizes as a light source at least one Distributed Bragg Reflector Laser, Optical Parametric Oscillator Laser, External Cavity Diode Laser, Quantum Cascade Laser or Distributed Feedback Laser.

8. A process in accordance with claim 4 wherein said spectrometer utilizes as a light source at least one Distributed Bragg Reflector Laser, Optical Parametric Oscillator Laser, External Cavity Diode Laser, Quantum Cascade Laser or Distributed Feedback Laser.

9. A process in accordance with claim 1 wherein all said absorption peaks are of a wavelength accessible by said spectrometer utilizing a single laser.

10. A process in accordance with claim 2 wherein all said absorption peaks are of a wavelength accessible by said spectrometer utilizing a single laser.

11. A process in accordance with claim 3 wherein all said absorption peaks are of a wavelength accessible by said spectrometer utilizing a single laser.

12. A process in accordance with claim 4 wherein all said absorption peaks are of a wavelength accessible by said spectrometer utilizing a single laser.

13. A process in accordance with claim 9 wherein said laser is a current tunable Distributed Feedback Laser.

14. A process in accordance with claim 10 wherein said laser is a current tunable Distributed Feedback Laser.

15. A process in accordance with claim 11 wherein said laser is a current tunable Distributed Feedback Laser.

16. A process in accordance with claim 12 wherein said laser is a current tunable Distributed Feedback Laser.

17. A process in accordance with claim 13 wherein said Distributed Feedback Laser is also tunable by altering the temperature of said laser.

18. A process in accordance with claim 14 wherein said Distributed Feedback Laser is also tunable by altering the temperature of said laser.

19. A process in accordance with claim 15 wherein said Distributed Feedback Laser is also tunable by altering the temperature of said laser.

20. A process in accordance with claim 16 wherein said Distributed Feedback Laser is also tunable by altering the temperature of said laser.

21. A process in accordance with claim 9 wherein said laser is an External Cavity Diode Laser having a micromotor wide range tuning mechanism and a PZT narrow range tuning mechanism.

22. A process in accordance with claim 10 wherein said laser is an External Cavity Diode Laser having a micromotor wide range tuning mechanism and a PZT narrow range tuning mechanism.

23. A process in accordance with claim 11 wherein said laser is an External Cavity Diode Laser having a micromotor wide range tuning mechanism and a PZT narrow range tuning mechanism.

24. A process in accordance with claim 12 wherein said laser is an External Cavity Diode Laser having a micromotor wide range tuning mechanism and a PZT narrow range tuning mechanism.

25. A process in accordance with claim 5 wherein said laser is a broadly tunable Optical Parametric Oscillator Laser.

26. A process in accordance with claim 6 wherein said laser is a broadly tunable Optical Parametric Oscillator Laser

27. A process in accordance with claim 7 wherein said laser is a broadly tunable Optical Parametric Oscillator Laser.

28. A process in accordance with claim 8 wherein said laser is a broadly tunable Optical Parametric Oscillator Laser.

29. A process in accordance with claim 1 wherein the height of each successive peak identified in step ii) differs from the immediately previously identified peak of the same series by a factor of no more than the CDR of said successive peak.

30. A process in accordance with claim 3 wherein the height of each successive peak identified in step ii) differs from the immediately previously identified peak of the same series by a factor of no more than the CDR of said successive peak.

31. A process in accordance with claim 4 wherein the height of each successive peak identified in step ii) differs from the immediately previously identified peak of the same series by a factor of no more than the CDR of said successive peak.
